(19) United States
(12) Patent Application Publication
(10) Pub. No.: US 2009/0237680 A1
(43) Pub. Date: Sep. 24, 2009

(54) IMAGE PROCESSING APPARATUS, IMAGE PROCESSING METHOD, AND COMPUTER PROGRAM FOR IMAGE PROCESSING

(75) Inventor: Masaya USUI, Shiojiri-shi (JP)

Correspondence Address: HOGAN & HARTSON L.L.P., 1999 AVENUE OF THE STARS, SUITE 1400, LOS ANGELES, CA, 90067, US

(73) Assignee: Seiko Epson Corporation, Tokyo (JP)

(21) Appl. No.: 12/402,111

(22) Filed: Mar. 11, 2009

(30) Foreign Application Priority Data
Mar. 24, 2008 (JP) 2008-076255

(51) Int. Cl. G06K 15/02

(52) U.S. Cl. 358/1.2

(57) ABSTRACT

An image processing apparatus includes: a deformation area setting unit that sets an enlargement area and a reduction area in an image; a deformation processing unit that enlarges the enlargement area in a specific direction and reduces the reduction area in the specific direction; and a face detecting unit that detects a face in the image. The deformation area setting unit sets the enlargement area so as to be laid from an enlargement start position determined on the basis of the position of the face in the specific direction to the end of the image in the specific direction.

### BACKGROUND

1. Technical Field

The present invention relates to an image processing technique that deforms an image.

2. Related Art

An image processing technique has been known which deforms a person's face smaller in a digital image (for example, JP-A-2004-318204). JP-A-2004-318204 discloses an image processing apparatus that sets a portion of a face image (an area indicating a cheek image) as a corrected area, divides the corrected area into a plurality of small areas according to a predetermined pattern, and enlarges or reduces the image at a magnification that is set for each of the small areas to deform a face.

However, in image processing that sets the corrected area and corrects an image, a process requiring a large amount of computation, such as a process of setting the corrected area or a process of enlarging or reducing the small areas, is performed. Therefore, the amount of computation for performing image processing is excessively increased. In general, the above-mentioned problem arises in a general process of deforming an image as well as a process of deforming a person's face.

### SUMMARY

An advantage of some aspects of the invention is that it provides a technique capable of reducing the amount of computation required for an image deforming process of deforming an image.

According to a first aspect of the invention, an image processing apparatus includes: a deformation area setting unit that sets an enlargement area and a reduction area in an image; a deformation processing unit that enlarges the enlargement area in a specific direction and reduces the reduction area in the specific direction; and a face detecting unit that detects a face in the image. The deformation area setting unit sets the enlargement area so as to be laid from an enlargement start position determined on the basis of the position of the face in the specific direction to the end of the image in the specific direction.

According to the above-mentioned aspect, enlargement and reduction are performed in one direction to deform an image. Therefore, it is possible to reduce the amount of computation required for an image deforming process. In addition, the start position of the enlargement area laid across the end of the image in a specific direction is determined on the basis of the position of the face. Therefore, it is possible to set an enlargement area at an appropriate position with respect to the position of the face.

According to a second aspect of the invention, in the image processing apparatus according to the first aspect, when the face detecting unit detects a plurality of faces, the deformation area setting unit may set the enlargement area on the basis of a face that is closest to the end of the image in the specific direction.

According to the above-mentioned aspect, it is possible to set an enlargement area at an appropriate position with respect to the position of any face detected by the face detecting unit.

According to a third aspect of the invention, in the image processing apparatus according to the first or second aspect, the deformation area setting unit may set the enlargement area and the reduction area so as to be symmetric with respect to the center of the image in the specific direction.

According to the above-mentioned aspect, since the enlargement area and the reduction area are set so as to be symmetric with respect to the center of the image in the specific direction, enlargement and reduction can be symmetrically performed with respect to the center. Therefore, it is possible to enlarge and reduce the entire image by using information about an area from the center to the end of the image in the specific direction as information used for enlargement and reduction. As a result, it is possible to reduce memory capacity required for an image deforming process.

According to a fourth aspect of the invention, in the image processing apparatus according to the third aspect, the reduction area may be arranged at the center of the image in the specific direction, and the deformation processing unit may perform the reduction and the enlargement from the center to the end of the image in the specific direction.

According to the above-mentioned aspect, in order to deform an image, first, the reduction area arranged at the center of the image is reduced. Even when an image before deformation is sequentially replaced with a deformed image, starting from the center, it is possible to generate the deformed image with the image before deformation that is not replaced, by performing reduction first in order to deform an image. Therefore, it is possible to store the images before and after deformation in one area. As a result, it is possible to reduce memory capacity required for an image deforming process.

According to a fifth aspect of the invention, in the image processing apparatus according to the first aspect, the deformation area setting unit may set the reduction area as an area including a portion of the face.

According to the above-mentioned aspect, since the reduction area is set as an area including a portion of the face, it is possible to prevent a face from being enlarged in a specific direction. Therefore, it is possible to prevent incongruity from occurring in a deformed image due to the enlargement of a face.

According to a sixth aspect of the invention, in the image processing apparatus according to the fifth aspect, when a distance between one end of the image in the specific direction and the reduction area is less than a predetermined value, the deformation area setting unit may set the enlargement area only between the reduction area and the other end of the image.

According to the above-mentioned aspect, when the distance between one end of the image and the reduction area is less than a predetermined value and no enlargement area is set therebetween, it is possible to set an enlargement area having a sufficient width between the reduction area and the other end of the image. Therefore, it is possible to align images before and after deformation substantially in the same specific direction without increasing the enlargement ratio of the enlargement area. In addition, it is possible to reduce the amount of computation required for a deforming process by narrowing the enlargement area.

According to a seventh aspect of the invention, in the image processing apparatus according to the sixth aspect, the deformation processing unit may perform the reduction and the enlargement from the one end of the reduction area to the other end thereof.

According to the above-mentioned aspect, the reduction and the enlargement of an image in a specific direction are performed from one end of the reduction area closest to the end of the image and the other end thereof. Therefore, reduction is performed first in the image deforming process. Even when an image before deformation is sequentially replaced with a deformed image, starting from the center, it is possible to generate the deformed image with the image before deformation that is not replaced, by performing reduction first in order to deform an image. Therefore, it is possible to store the images before and after deformation in one area. As a result, it is possible to reduce memory capacity required for an image deforming process.

According to an eight aspect of the invention, in the image processing apparatus according to any one of the fifth to seventh aspects, when the enlargement areas are sets at both sides of the reduction area in the specific direction, the deformation processing unit may perform the reduction and the enlargement from the center of the reduction area to the end of the image.

According to the above-mentioned aspect, when the enlargement areas are set at both sides of the reduction area, deformation performed from the center of the reduction area to one end of an image that is closer to the center of the reduction area is the same as that performed from the center of the reduction area to the other end of the image. Therefore, it is possible to enlarge and reduce the entire image by using information about an area from the center of the reduction area to the other end of the image as information used for enlargement and reduction. As a result, it is possible to reduce memory capacity required for an image deforming process.

The invention can be achieved by various aspects. For example, the invention can be achieved in the forms of an image processing method and apparatus, an image output apparatus, an image printing apparatus, an image output method, and an image printing method using the image processing method or the image processing apparatus, a computer program for executing the functions of the apparatuses or the methods, a recording medium having the computer program recorded thereon, and data signals that include the computer program and are transmitted as carrier waves.

### BRIEF DESCRIPTION OF THE DRAWINGS

The invention will be described with reference to the accompanying drawings, wherein like numbers reference like elements.

FIG. 1 is a diagram schematically illustrating the structure of a printer according to a first embodiment.

FIG. 2 is a diagram illustrating an example of a user interface including a list of images.

FIG. 3 is a flowchart illustrating the flow of a face shape correcting and printing process when the printer corrects and prints a face shape.

FIGS. 4A to 4C are diagrams illustrating an example in which a face shape correcting process is performed on an image corresponding to a thumbnail image TN1 shown in FIG. 2.

FIG. 5 is a flowchart illustrating the flow of a deforming process performed in Step S400.

FIGS. 6A to 6C are diagrams schematically illustrating the deforming process when a deformation direction is the horizontal direction.

FIGS. 7A to 7C are diagrams illustrating an example in which the face shape correcting process is performed on an image corresponding to a thumbnail image TN2 shown in FIG. 2.

FIGS. 8A and 8B are diagrams illustrating an example in which a face shape correcting process according to a second embodiment is performed on an image corresponding to the thumbnail image TN1 shown in FIG. 2.

FIG. 9 is a diagram schematically illustrating the structure of a printer according to a third embodiment.

FIG. 10 is a flowchart illustrating the flow of a face shape correcting and printing process according to the third embodiment.

FIG. 11A and 11B are diagrams illustrating an example in which a face shape correcting process according to the third embodiment is performed on an image corresponding to the thumbnail image TN1 shown in FIG. 2.

FIGS. 12A and 12B are diagrams illustrating an example in which the face shape correcting process according to the third embodiment is performed on an image corresponding to a thumbnail image TN3 shown in FIG. 2.

FIG. 13 is a diagram schematically illustrating the structure of a printer according to a fourth embodiment.

FIG. 14 is a flowchart illustrating the flow of a face shape correcting and printing process according to the fourth embodiment.

FIGS. 15A and 15B are diagrams illustrating an example in which a face shape correcting process according to the fourth embodiment is performed on an image corresponding to the thumbnail image TN3 shown in FIG. 2.

FIG. 16 is a diagram schematically illustrating the structure of a printer according to a fifth embodiment.

FIG. 17 is a flowchart illustrating the flow of a face shape correcting and printing process according to the fifth embodiment.

FIG. 18A to 18C are diagrams illustrating an example in which a face shape correcting process according to the fifth embodiment is performed on an image corresponding to the thumbnail image TN1 shown in FIG. 2.

FIGS. 19A and 19B are diagrams illustrating an example of a face arrangement specifying process performed in Step S200 shown in FIG. 3.

FIG. 20 is a diagram illustrating an example of a face area deforming process performed in Step S800d shown in FIG. 17.

FIG. 21 is a diagram illustrating an example of the face area deforming process performed in Step S800d shown in FIG. 17.

FIG. 22 is a diagram illustrating an example of the face area deforming process performed in Step S800d shown in FIG. 17.

FIG. 23 is a diagram illustrating an example of the face area deforming process performed in Step S800d shown in FIG. 17.

### DESCRIPTION OF EXEMPLARY EMBODIMENTS

Hereinafter, exemplary embodiments of the invention will be described in the following order:

A. First embodiment;

B. Second embodiment;

C. Third embodiment;

D. Fourth embodiment;

E. Fifth embodiment;

F. Specification of arrangement of face;

G. Deformation of face area; and

H. Modifications.

### A. First Embodiment

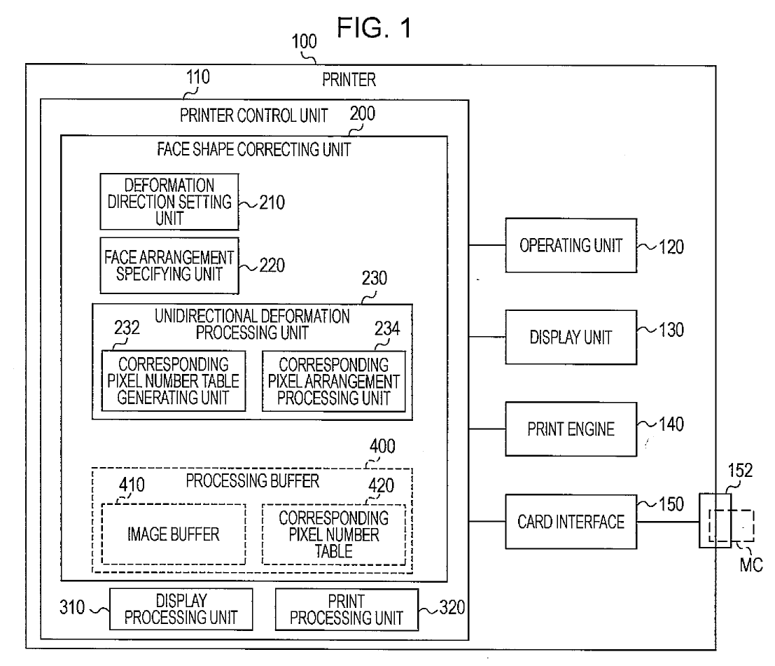

FIG. 1 is a diagram schematically illustrating the structure of a printer 100 according to a first embodiment of the invention. The printer 100 is a color ink jet printer corresponding to so-called direct printing that performs printing on the basis of image data obtained from, for example, a memory card MC. The printer 100 includes a printer control unit 110 that controls all components of the printer 100, an operating unit 120 that includes buttons or a touch panel, a display unit 130 that is composed of a liquid crystal display, a print engine 140, and a card interface 150. The printer 100 may further include interfaces for data communication with other apparatuses (for example, a digital still camera or a personal computer).

The print engine 140 is a printing mechanism that performs printing on the basis of print data. The card interface 150 is for data communication with the memory card MC inserted into a card slot 152. In this embodiment, image data, which is RGB data, is stored in the memory card MC, and the printer 100 acquires the image data stored in the memory card MC through the cart interface 150.

The printer control unit 110 includes a face shape correcting unit 200, a display processing unit 310, and a print processing unit 320 as functional blocks. The printer control unit 110 is composed of a computer including a CPU, a ROM, and a RAM (which are all not shown). The CPU executes a program stored in the ROM or the RAM to serve as the functional blocks 200, 310, and 320.

The display processing unit 310 controls the display unit 130 to display, for example, a process menu or a message. The print processing unit 320 generates print data from image data, and controls the print engine 140 to print an image on the basis of the print data.

The face shape correcting unit 200 includes a deformation direction setting unit 210, a face arrangement specifying unit 220, and a unidirectional deformation processing unit 230. The unidirectional deformation processing unit 230 includes a corresponding pixel number table generating unit 232 and a corresponding pixel arrangement processing unit 234. The unidirectional deformation processing unit 230 uses an image buffer 410 and a corresponding pixel number table 420 in a processing buffer 400, which is a temporary storage area of the RAM, to perform a face shape correcting process. The functions of these units will be described below.

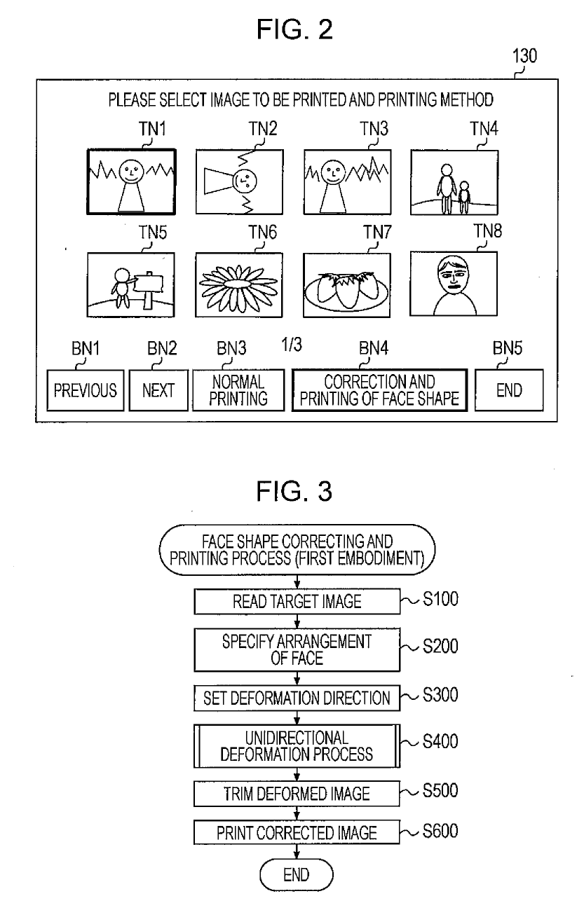

The printer 100 prints an image on the basis of the image data stored in the memory card MC. When the memory card MC is inserted into the card slot 152, the display processing unit 310 controls the display unit 130 to display a user interface including a list of images stored in the memory card MC. FIG. 2 is a diagram illustrating an example of the user interface including a list of images. In this embodiment, a list of images is displayed using thumbnail images included in image data (image file) that is stored in the memory card MC. In the user interface shown in FIG. 2, eight thumbnail images TN1 to TN8 and five buttons BN1 to BN5 are displayed.

When the user selects an image from the user interface shown in FIG. 2 and operates a general printing button BN3, the printer 100 performs a general printing process that generally prints the selected image. When the user selects an image from the user interface and operates a face shape correcting and printing button BN4, the printer 100 performs a face shape correcting and printing process that reduces the width of a face in the selected image to correct the face shape and prints the corrected image. In the example shown in FIG. 2, a thumbnail image TN1 is selected, and the face shape correcting and printing button BN4 is operated. Therefore, the printer 100 performs the face shape correcting process on an image corresponding to the thumbnail image TN1 and prints the image subjected to the face shape correcting process (corrected image).

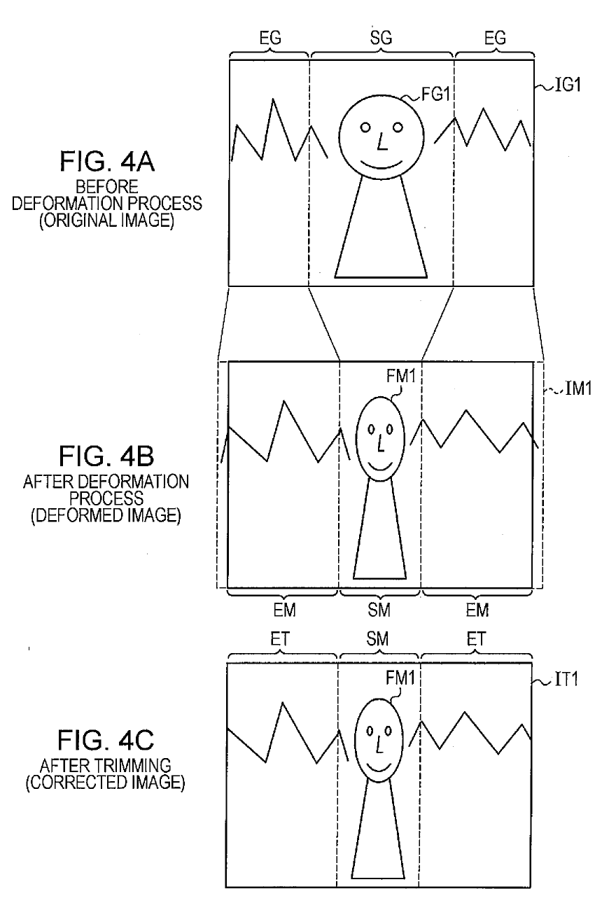

FIG. 3 is a flowchart illustrating the flow of the face shape correcting and printing process when the printer 100 corrects a face shape and prints the corrected image. As described above, the face shape correcting and printing process is performed by a CPU of the printer control unit 110 when the user operates the face shape correcting and printing button EN4 on the user interface shown in FIG. 2. FIGS. 4A to 4C are diagrams illustrating an example of the face shape correcting process in which an image IG1 corresponding to the thumbnail image TN1 is corrected to generate a corrected image IT1.

In Step S100, the face shape correcting unit 200 (FIG. 1) acquires a target image to be subjected to the face shape correcting process. Specifically, the face shape correcting unit 200 reads an image (target image) corresponding to the thumbnail image TN1, which is selected from the user interface shown in FIG. 2 by the user, from the memory card MC (FIG. 1) and stores the read image in the image buffer 410. In the following description, an image to be subjected to face shape correction is referred to as an ‘original image’.

In Step S200, the face arrangement specifying unit 220 (FIG. 1) analyzes the original image and specifies the arrangement of a person's face in the original image. Specifically, the face arrangement specifying unit detects a person's face from the original image and specifies the inclination of the detected face image. In the first embodiment, the long side of the image is treated as the horizontal direction, and the short side of the image is treated as the vertical direction. Therefore, the inclination of a face means an angle formed between the vertical direction of the face and the vertical direction of the image (that is, the short side). A detailed method of specifying the arrangement of a face will be described below. The face arrangement specifying unit 220 detects a person's face from the image when the arrangement of the face is specified. Therefore, the face arrangement specifying unit serves as a ‘face detecting unit’. The face detecting unit may detect at least one organ included in the face as long as it can specify the arrangement of the face. In addition, the face detecting unit may detect the entire head. Since the vertical direction or the horizontal direction of a face is determined with respect to the face, it can be referred to as a direction that is predetermined for the face.

In FIG. 4A, a face FG1 that is disposed substantially at the center of the original image IG1 is detected, and the inclination of the face FG1 is specified. As shown in FIG. 4A, the vertical direction of the face FG1 is substantially aligned with the vertical direction of the image IG1. Therefore, the inclination of the face specified in Step S200 is approximately 0°.

In Step S300 of FIG. 3, the deformation direction setting unit 210 (FIG. 1) sets the direction in which an image is enlarged and reduced in the face shape correcting process on the basis of the arrangement of the face specified in Step S200. Specifically, if the inclination of the face acquired in Step S200 is less than 45°, a deformation direction is set to the horizontal direction of the image. On the other hand, if the inclination of the face is more than 45°, the deformation direction is set to the vertical direction. If the inclination of the face is 45°, the deformation direction is set to a predetermined standard direction (for example, the horizontal direction). When image data includes Exif information, the direction may be changed to the standard direction, and the deformation direction may be set on the basis of transposition information included in the Exif information. When the inclination of the face is in a predetermined range including 45° (for example, in the range of 43° to 47°), the deformation direction may be set to the standard direction, or it may be set on the basis of the transposition information.

The vertical direction of the face is specified as a direction that is vertical to a line linking two pupils of the detected face, which will be described below. Therefore, the deformation direction is set to the direction of one of two sides of the image aligned with the horizontal direction and the vertical direction which has a smaller angle with respect to the line linking the pupils.

When an image includes a plurality of faces, a large face is preferentially used to set the deformation direction. That is, if the inclination of a large face is less than 45° and the inclination of a small face is more than 45°, the deformation direction is set to the horizontal direction. However, when an image includes a plurality of faces, the deformation direction may be set by other methods. For example, the deformation direction may be set on the basis of the inclination of a face that is closest to 0° or 90°, or it may be set on the basis of the direction in which a plurality of faces are arranged.

In the example shown in FIG. 4A, as described above, the inclination of the face FG1 is approximately 0°. Therefore, in Step S300 (FIG. 3), the deformation direction is set to the horizontal direction of the image IG1.

In Step S400, the unidirectional deformation processing unit 230 (FIG. 1) performs a unidirectional deformation process to reduce and enlarge the original image in the deformation direction, thereby generating an image (deformed image). Specifically, the unidirectional deformation processing unit reduces a reduction area having a predetermined width, which is disposed at the center of the original image in the deformation direction, in the deformation direction, and enlarges an enlargement area that is disposed outside the reduction area in the deformation direction. The width of the reduction area is set on the basis of the width of the face detected in Step S200 or the length of the original image in the deformation direction.

For example, the width of the reduction area may be 2.5 times larger than the width of the face, and it may be 50% of the length of the original image in the deformation direction.

In general, in an image having a person as a subject, the person is arranged at the center of the image. Therefore, the reduction area is arranged at the center of the original image to deform a person's face included in the image such that the width thereof is reduced. In the first embodiment, the reduction area is reduced at a predetermined reduction ratio (for example, 90%). However, the reduction ratio may be changed by instructions from the user. In addition, the enlargement ratio of the enlargement area is appropriately set on the basis of the width of the reduction area and the reduction ratio. Details of the unidirectional deformation process will be described below.

In the first embodiment, as shown in FIG. 4A, a reduction area SG is arranged at the center of the original image IG1 in the horizontal direction (deformation direction), and enlargement areas EG are arranged on the left and right sides of the reduction area. As shown in FIG. 4B, the unidirectional deformation process is performed to deform the reduction area SG of the original image IG1 into a reduced area SM having a length that is reduced in the deformation direction and deform the enlargement areas EG of the original image IG1 into enlarged areas EM each having a length that is increased in the deformation direction. Therefore, in a deformed image IM1, a face FM1 is narrower than the face FG1 of the original image IG1.

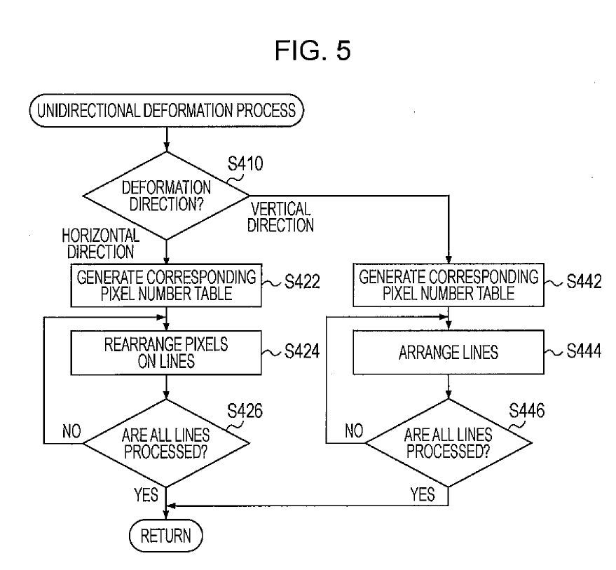

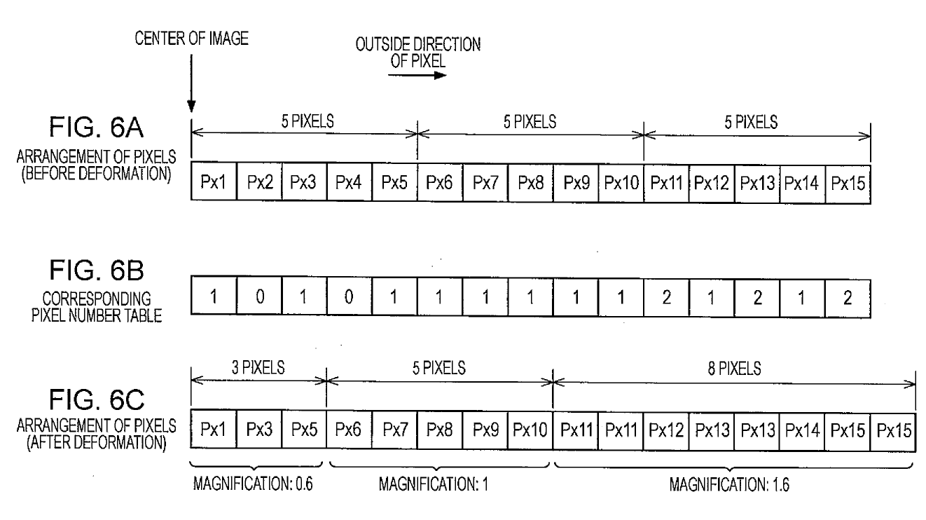

FIG. 5 is a flowchart illustrating the flow of the unidirectional deformation process performed in Step S400. FIGS. 6A to 6C are diagrams schematically illustrating the unidirectional deformation process when the deformation direction is the horizontal direction. FIG. 6A shows the arrangement of pixels before the unidirectional deformation process is performed, that is, before correction. FIG. 6B shows an example of a corresponding pixel number table 420. FIG. 6C shows the arrangement of pixels in an image subjected to the unidirectional deformation process (deformed image).

In Step S410, the unidirectional deformation processing unit 230 determines whether the deformation direction is the horizontal direction or the vertical direction. If it is determined that the deformation direction is the horizontal direction, the process proceeds to Step S422. On the other hand, if it is determined that the deformation direction is the vertical direction, the process proceeds to Step S442.

In Step S422, the corresponding pixel number table generating unit 232 of the unidirectional deformation processing unit 230 generates the corresponding pixel number table 420. The corresponding pixel number table 420 indicates the number of pixels of a deformed image corresponding to the pixels of the original image. The corresponding pixel number table generating unit 232 determines the corresponding number of pixels of a deformed image (corresponding-pixel number) on the basis of the reduction ratio and the enlargement ratio (magnification) that are set for each of the image areas arranged in the horizontal direction. Then, the determined number of corresponding pixels is stored in the corresponding pixel number table 420, thereby generating the corresponding pixel number table 420. In the first embodiment, when the deformation direction is the horizontal direction, deformation is symmetrically performed with respect to the vertical axis. Therefore, the number of pixels that is half the total number of pixels in the horizontal direction is enough for the size of the corresponding pixel number table 420. As a result, it is possible to reduce memory capacity required for the unidirectional deformation process.

For example, the number of corresponding pixels can be determined by binarizing a decimal part of a magnification using a halftone process to determine an arrangement pattern of 0 and 1 and adding an integer part of the magnification to the value 0 or 1 of the arrangement pattern. A known method, such as dither or error diffusion, can be used as the halftone process. In addition, a previously stored arrangement pattern may be used for each decimal part of the magnification. In Step S422, a previously created corresponding pixel number table may be used instead of generating the corresponding pixel number table 420.

In FIGS. 6A to 6C, magnifications of 0.6, 1, and 1.6 in the horizontal direction are set to three sets of five pixels arranged from the center of the original image. Therefore, in the first set of five pixels Px1 to Px5 from the center of the original image, a corresponding pixel number of 1 is set to three pixels Px1, Px3, and Px5, and a corresponding pixel number of 0 is set to the remaining two pixels Px2 and Px4. In the next set of five pixels Px6 to Px10 to which a magnification of 1 is set, a corresponding pixel number of 1 is set to all the pixels Px6 to Px10. In a set of five pixels Px11 to Px15 which is furthest away from the center of the original image and to which a magnification of 1.6 is set, a corresponding pixel number of 2 is set to three pixels Px11, Px13, and Px15, and a corresponding pixel number of 1 is set to the remaining two pixels Px12 and Px14.

In Step S424 of FIG. 5, the corresponding pixel arrangement processing unit 234 (FIG. 1) rearranges pixels on one line of the original image stored in the image buffer 410. The line is a process unit during image processing, and means a linear area on an image that extends in the horizontal direction and has a length corresponding to the total number of pixels in the horizontal direction and a width corresponding to one pixel. However, a linear area extending in the vertical direction may be processed as a line according to a method of storing images in the image buffer 410.

The corresponding pixel arrangement processing unit 234 (FIG. 1) rearranges the pixels stored in the image buffer 410 in the outward direction from the center of the image, according to the number of corresponding pixels stored in the corresponding pixel number table 420. It is possible to rearrange pixels, with the pixels before rearrangement remaining in the image buffer 410, by rearranging the pixels in the outward direction from the center of the image. Therefore, it is possible to rearrange pixels using a single image buffer 410. As a result, it is possible to reduce memory capacity required for the unidirectional deformation process.

In the example shown in FIGS. 6A to 6C, as shown in FIG. 6C, the pixels Px1, Px3, and Px5 to Px10 having a corresponding pixel number of 1 are sequentially arranged from the center of the image. Then, two pixels Px11, one pixel Px12, two pixels Px13, one pixel Px14, and two pixels Px15 are arranged according to the number of corresponding pixels. In this way, two areas of five pixels closest to and furthest away from the center of the original image are reduced and enlarged at magnifications of 0.6 and 1.6, respectively. In the first embodiment, as shown in FIGS. 6A to 6C, the magnification of each area in the horizontal direction is set such that the number of pixels after rearrangement is slightly larger than the number of pixels of the original image. Therefore, the length of the deformed image in the deformation direction is more than that of the original image in the deformation direction.

In Step S426 of FIG. 5, the unidirectional deformation processing unit 230 determines whether pixels on all the lines of the original image are completely rearranged. If it is determined that the pixels on all the lines are completely rearranged, the unidirectional deformation process shown in FIG. 5 ends, and the process returns to the fade shape correcting and printing process shown in FIG. 3. On the other hand, if it is determined that the pixels on all the lines are not completely rearranged, the process returns to Step S424, and Steps S424 and S426 are repeatedly performed until the pixels on all the lines are completely rearranged.

In Step S442, the corresponding pixel number table generating unit 232 generates the corresponding pixel number table 420, similar to Step S422. When the deformation direction is the vertical direction, a corresponding pixel number table 420 corresponding to the number of pixels in the vertical direction is generated. A method of determining the number of corresponding pixels is the same as that in Step S420, and thus a description thereof will be omitted.

In Step S444, the unidirectional deformation processing unit 230 arranges the lines of the original image in a deformed image storage area of the image buffer 410 with reference to the corresponding pixel number table 420. Specifically, the unidirectional deformation processing unit 230 adds one line of the original image stored in the image buffer 410 to the deformed image storage area of the image buffer 410 as a line corresponding to a corresponding pixel number.

In Step S446, the unidirectional deformation processing unit 230 determines whether all the lines of the original image are completely arranged. If it is determined that all the lines of the original image are completely arranged, the unidirectional deformation process shown in FIG. 5 ends, and the process returns to the face shape correcting and printing process shown in FIG. 3. On the other hand, if it is determined that all the lines of the original image are not completely arranged, the process returns to Step S444, and Steps S444 and S446 are repeatedly performed until all the lines are completely arranged.

When the process returns from the unidirectional deformation process shown in FIG. 5, in Step S500 of FIG. 3, the unidirectional deformation processing unit 230 trims the deformed image. In the first embodiment, as shown in FIG. 4B, the length of the deformed image subjected to the unidirectional deformation process in the deformation direction is greater than that of the original image in the deformation direction. Therefore, when the edge of the deformed image in the deformation direction is trimmed, the deformed image becomes a corrected image having a size that is equal to that of the original image. In the example shown in FIGS. 4A to 4C, the left and right ends of the deformed image IM1 shown in FIG. 4B are trimmed, and a corrected image IT1 having a length that is equal to that of the original image IG1 in the horizontal direction is generated.

In Step S600 of FIG. 3, the print processing unit 320 performs, for example, a color conversion process or a halftone process on the corrected image to generate print data. Then, the print processing unit provides the generated print data to the print engine 140, and the print engine prints an image subjected to the face shape correcting process.

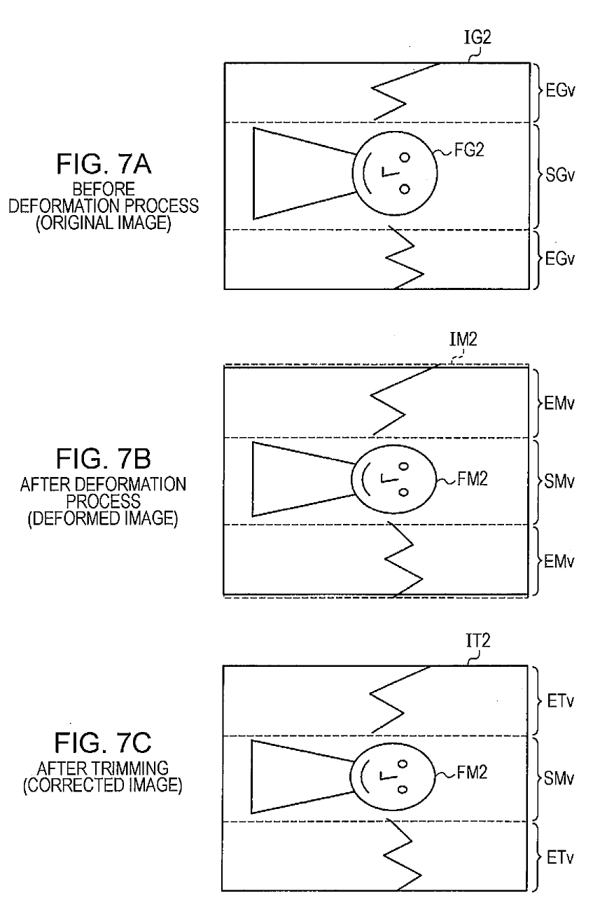

FIGS. 7A to 7C are diagrams illustrating an example in which the face shape correcting process is performed on an image IG2 corresponding to the thumbnail image TN2 shown in FIG. 2. FIG. 7A shows an original image IG2 before the face shape correcting process is performed. FIG. 7B shows a deformed image IM2 subjected to the unidirectional deformation process in Step S400, and FIG. 7C shows a corrected image IT2 subjected to trimming in Step S500.

As shown in FIG. 7A, since the vertical direction of a person's face FG2 of the original image IG2 is substantially aligned with the horizontal direction of the image IG2, the inclination of the face is specified at substantially 90° in Step S200. Therefore, in Step S300 (FIG. 3), the deformation direction is set to the vertical direction of the original image IG2.

In the example shown in FIGS. 7A to 7C, since the deformation direction is the vertical direction, a reduction area SGv is arranged at the center of the original image IG2 in the vertical direction. Areas EGv that are arranged at the upper and lower parts of the image IG2, that is, upper and lower areas of the reduction area SGv are set to enlargement areas. Then, in Step S400, the unidirectional deformation process is performed on the original image IG2 to generate the deformed image IM2 shown in FIG. 7B. The unidirectional deformation process causes the length of a reduced area SMv of the deformed image IM2 in the deformation direction (vertical direction) to be smaller than that of the reduction area SGv of the original image IG2. In addition, the length of an enlarged area EMv of the deformed image IM2 in the vertical direction is greater than that of the enlargement area EGv of the original image IG2. In this way, as shown in FIG. 7A, in the image IG2 in which the vertical direction of the face FG2 is aligned with the horizontal direction of the image, a face FM2 in the deformed image IM2 is narrower than the face FG2 in the original image IG2. After the deformed image IM2 is generated, as shown in FIG. 7C, the upper and lower ends of the deformed image IM2 are trimmed in Step S500 to generate a corrected image IT2 having a length that is equal to that of the original image IG2 in the vertical direction.

As described above, according to the first embodiment, the deformation direction of an image is set from the arrangement of a face in the original image, and the original image is reduced or enlarged in the deformation direction. In this way, it is possible to reduce the width of a person's face regardless of the direction of a person's face.

Furthermore, in the first embodiment, when the horizontal direction, that is, the direction of a line, which is the process unit of an image, is the deformation direction, it is possible to reduce memory capacity required to change the direction of a line by arranging a reduced area and an enlarged area at objects from the center of the image.

In the first embodiment, after a corrected image is generated by trimming in Step S500, print data is generated in Step S600. However, in Step S424 or Step S444 (FIG. 5), print data may be generated at the time when a process for each line is completed. In this case, when the deformation direction is the horizontal direction, pixels at both ends of each line are trimmed. On the other hand, when the deformation direction is the vertical direction, the unidirectional deformation process is sequentially performed from the first line, and stops when it reaches a predetermined number of lines, thereby performing trimming. Therefore, the trimmed corrected image is obtained by trimming one end of the deformed image in the vertical direction.

### B. Second Embodiment

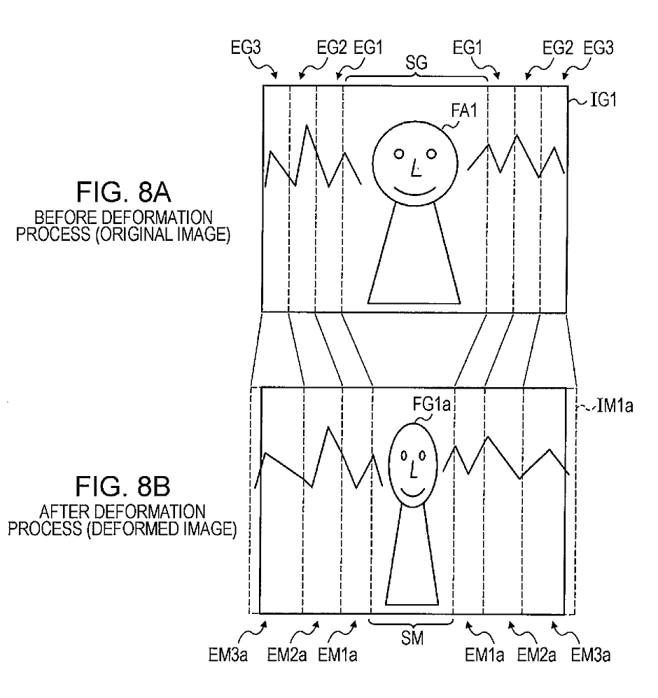

FIGS. 8A and 8B are diagrams illustrating an example in which a face shape correcting process according to a second embodiment is performed on an image IG1 corresponding to the thumbnail image TN1 shown in FIG. 2. The second embodiment is similar to the first embodiment shown in FIG. 4 except for the enlargement of an enlarged area.

As shown in FIG. 8A, in the second embodiment, two sets of three enlargement areas EG1 to EG3 are provided on the left and right sides of a reduction area SG. The enlargement ratios of the enlargement areas EG1 to EG3 are set such that the enlargement area EG3 that is furthest away from the center of the image in the deformation direction (that is, the reduction area SG) has the highest enlargement ratio, followed by the enlargement areas EG2 and EG1. Therefore, in a deformed image IM1a shown in FIG. 8B, an image in an enlarged area EM1a that is closest to a reduced area SM is hardly deformed, but an image in an enlarged area EM3a that is furthest away from the reduced area SM is greatly deformed.

As described above, in the second embodiment, it is possible to reduce incongruity between the reduced area SM and the enlarged area EM1a of the deformed image IM1a due to a difference in magnification by reducing the enlargement ratio of the enlargement area EG1 that is closest to the reduction area SG. In addition, it is possible to sufficiently increase the length of the deformed image IM1a in the deformation direction by increasing the enlargement ratio of the outermost enlargement area EG3. Therefore, it is possible to prevent a blank from being formed at the end of the deformed image IM1a in the deformation direction.

In the second embodiment, two sets of three enlargement areas EG1 to EG3 having different enlargement ratios are provided at both sides of the reduction area SG. In general, the enlargement ratio of an area close to the reduction area may be lower than that of an area further away from the reduction area. In addition, the enlargement ratio may not be necessarily increased monotonously as the distance from the reduction area is increased. In this case, since the enlargement ratio of an area close to the reduction area is low, it is possible to reduce incongruity between the reduced area and the enlarged area in the deformed image.

### C. Third Embodiment

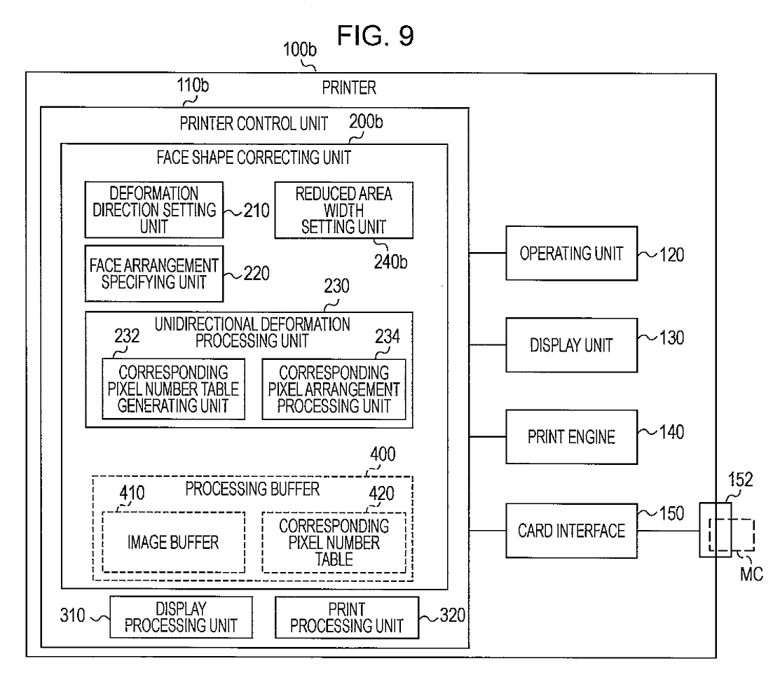

FIG. 9 is a diagram schematically illustrating the structure of a printer 100b according to a third embodiment of the invention. The printer 100b according to the third embodiment is similar to the printer 100 according to the first embodiment except that a reduced area width setting unit 240b is provided in a face shape correcting unit 200b.

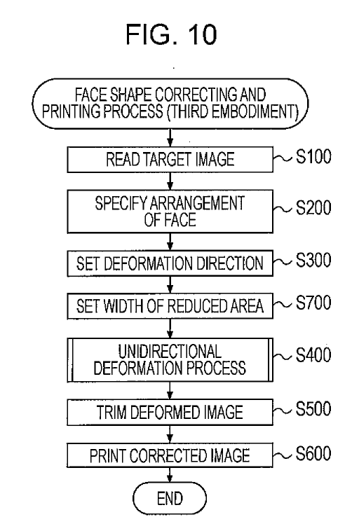

FIG. 10 is a flowchart illustrating the flow of a face shape correcting and printing process according to the third embodiment. The flowchart shown in FIG. 10 differs from the flowchart illustrating the flow of the face shape correcting and printing process according to the first embodiment shown in FIG. 3 in that Step S700 is added between Step S300 and Step S400.

In Step S700, the reduced area width setting unit 240b sets the width of a reduction area on the original image on the basis of the arrangement of the face specified in Step S200. Specifically, the reduced area width setting unit sets the width of the reduction area such that the face whose arrangement is specified in Step S200 is included in the reduction area.

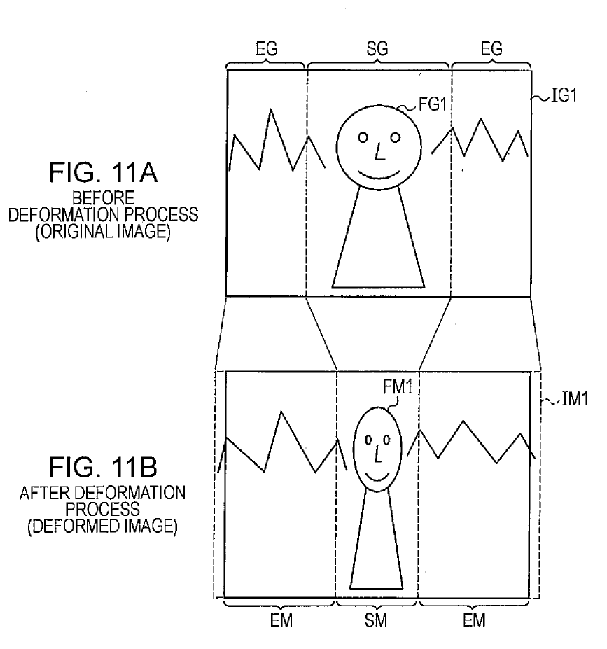

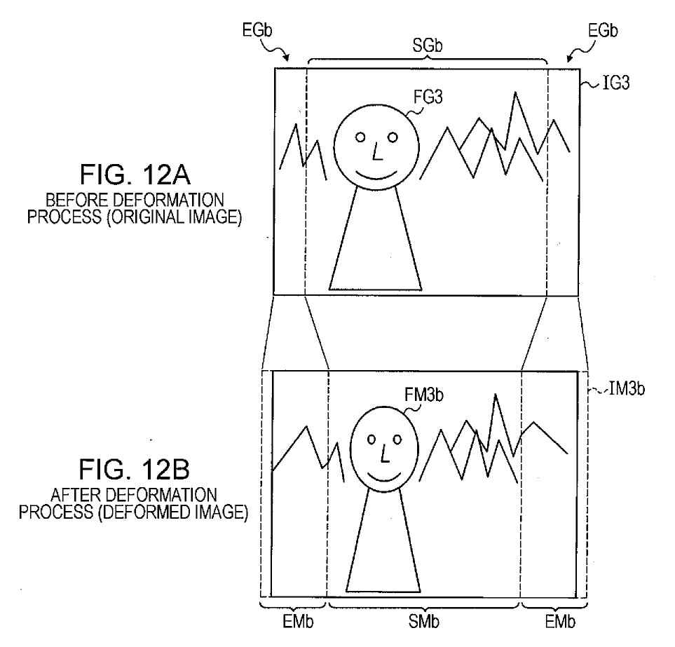

FIGS. 11A and 11B and FIGS. 12A and 12B are diagrams illustrating examples in which the face shape correcting process is performed on images IG1 and IG3 corresponding to the thumbnail images TN1 and TN3 shown in FIG. 2, respectively. FIGS. 11A and 11B are the same as FIGS. 4A to 4C. In FIG. 12A, the original image IG3 to be subjected to the face shape correcting process is different from the original image IG1 shown in FIG. 11A.

As shown in FIGS. 11A and 11B, when a face FG1 is disposed at the center of the original image IG1, the width of the reduction area SG in the original image IG1 is set on the basis of the width of the face FG1. Therefore, in the example shown in FIGS. 11A and 11B, the reduction area SG and the enlargement area EG are set by the same method as that in the first embodiment. Then, the same unidirectional deformation process as that in the first embodiment is performed on the original image IG1, and the widths of a reduced area SM and an enlarged area EM in a deformed image IM1 are equal to those in the first embodiment show in FIG. 4.

In contrast, as shown in FIG. 12A, an image IG3 corresponding to the thumbnail image TN3 shown in FIG. 2 is similar to the original image IG1 shown in FIG. 11A in that the vertical direction of a person's face is substantially aligned with the vertical direction of the image and the inclination of the face is approximately 0°. Therefore, in Step S300 (FIG. 3), the deformation direction is set to the horizontal direction of the image IG3. However, a person leans toward the left side of the image IG3 from the center of the image IG3 in the horizontal direction, which is the deformation direction. Therefore, in Step S700, the length of a reduction area SGb in the deformation direction (horizontal direction) is increased such that the reduction area includes the person's face FG3.

Then, when the unidirectional deformation process is performed, as shown in FIG. 12B, the length of a reduced area SGb in the horizontal direction in a deformed image IM3b is smaller than that of the reduction area SGb in the original image IG3. In addition, the length of an enlarged area EMb in the horizontal direction in the deformed image IM3b is greater than that of an enlargement area EGb in the original image IG3. In this way, a person's face FM3b of the deformed image IM3b is deformed so as to be narrower than the person's face FG3 of the original image IG3.

As described above, in the third embodiment, the width of a reduction area that is arranged at the center in the deformation direction is set according to the position of a person's face. Therefore, when a person's face is disposed in the vicinity of the center, the unidirectional deformation process is performed to reduce the width of the person's face to be smaller than that of the original image, similar to the first embodiment. When the face is disposed out of the center, the width of the reduction area is increased. Therefore, even when a face is disposed out of the center of an image, it is possible to deform the face such that the width of the face is smaller than that of the original image.

As described above, according to the third embodiment, the width of a reduction area is set according to the arrangement of a face. Therefore, even when the face is disposed out of the center of an image, it is possible to reduce the width of the face so as to be narrower than that in the original image. In addition, the width of a reduction area is set according to the arrangement of the face such that an enlargement area is set from the end of the reduction area to the end of the image. Therefore, the start position of the enlargement area can be set according to the arrangement of the face.

Similar to the first embodiment, in the third embodiment, the enlargement and reduction of an image are symmetrically performed with respect to the center of the image. Therefore, when the deformation direction is aligned with a direction in which a line extends, it is possible to arrange pixels of a deformed image without changing the arrangement of pixels of the original image. As a result, it is possible to reduce memory capacity required for the unidirectional deformation process.

In the third embodiment, the width of a reduction area is set such that a face in the original image is included in the reduction area. In general, it is preferable to prevent a face from being enlarged in the deformation direction. In this case, non-deformation areas that are not reduced and enlarged may be provided at both side of the reduction area and the non-deformation areas may be arranged such that a person's face is included in the non-deformation areas. In this case, it is possible to reduce memory capacity required for the unidirectional deformation process by symmetrically arranging the non-deformation areas with respect to the center of the image. When incongruity does not occur in the shape of a face in a deformed image although the face is laid across the enlarged area, a portion of the face in the original image may be laid across the enlargement area.

### D. Fourth Embodiment

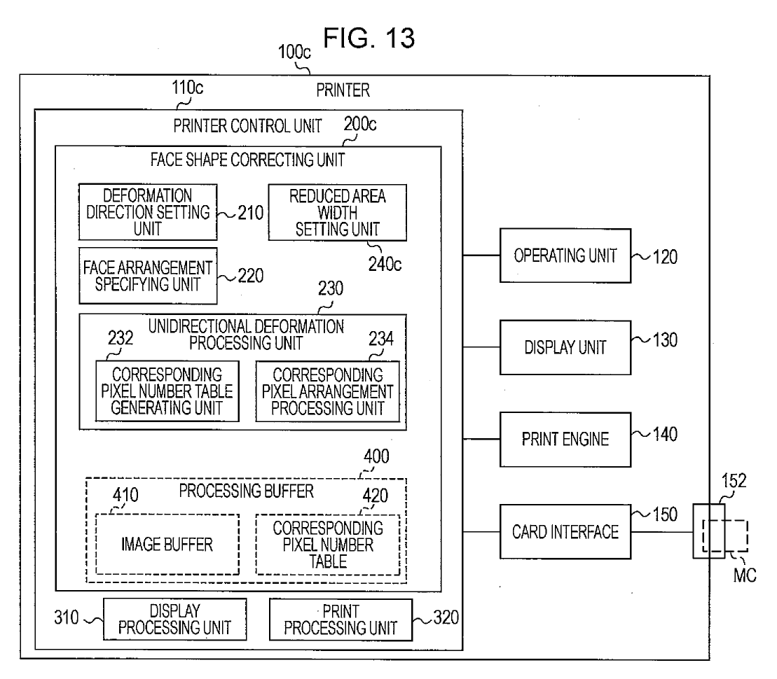

FIG. 13 is a diagram schematically illustrating the structure of a printer 10c according to a fourth embodiment of the invention. The printer 100c according to the fourth embodiment is similar to the printer 100 according to the first embodiment except that a reduced area position setting unit 240c is provided in a face shape correcting unit 200c.

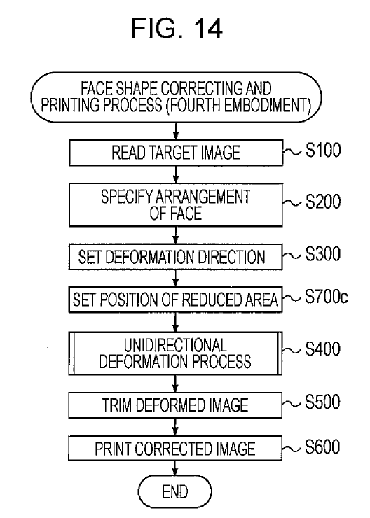

FIG. 14 is a flowchart illustrating the flow of a face shape correcting and printing process according to the fourth embodiment. The flowchart shown in FIG. 14 differs from the flowchart illustrating the flow of the face shape correcting and printing process according to the first embodiment shown in FIG. 3 in that Step S700c is added between Step S300 and Step S400.

In Step S700c, the reduced area position setting unit 240c sets the position of a reduction area on the original image on the basis of the arrangement of the face specified in Step S200. Specifically, an area having the width (for example, which is 2.5 times larger than the width of a face) calculated on the basis of the width of the face whose arrangement is specified in Step S200 is set as the reduction area. When the original image includes a plurality of faces, the reduction area is set for each of the faces. When the inclinations of the plurality of faces are divided on the basis of an angle of 45°, the reduction area is not set for the faces whose vertical direction is close to the deformation direction.

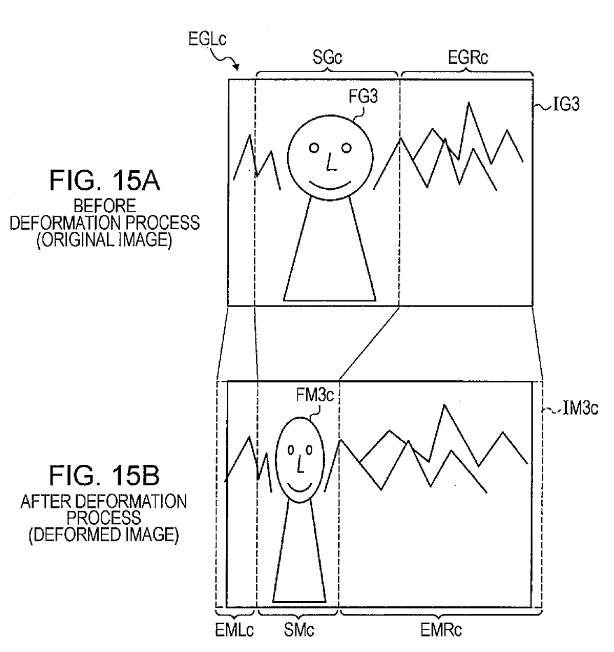

FIGS. 15A and 15B are diagrams illustrating an example in which a face shape correcting process is performed on an image IG3 corresponding to the thumbnail image TN3 shown in FIG. 2. FIG. 15A shows an original image IG3 before the face shape correcting process is performed. FIG. 15B shows a deformed image IM3c subjected to a unidirectional deformation process in Step S400.

As described above, in the image IG3 shown in FIG. 15A, since the inclination of the face is approximately 0°, the deformation direction is set to the horizontal direction of the image IG3. A person's face FG3 leans toward the left side of the image IG3 from the center of the image IG3 in the horizontal direction, which is the deformation direction. Therefore, in Step S700c, a reduction area is set to an area SGc having the face FG3 at its center. Enlargement areas EGLc and EGRc are set on the left and right sides of the reduction area SGc, respectively.

As such, when the center of the reduction area SGc leans toward one end of the image, the rearrangement of pixels in Step S424 of FIG. 5 is performed from the center of the reduction area SGc to the outside. In this case, the size of the corresponding pixel number table 420 corresponds to the number of pixels arranged from the center of the reduction area SGc to the other end of the image.

When the unidirectional deformation process is performed, as shown in FIG. 15B, the length of a reduced area SMc in a deformed image IM3c in the horizontal direction is smaller than that of the reduction area SGc of the original image IG3, and the lengths of enlarged areas EMLc and EMRc in the horizontal direction are greater than those of the enlargement areas of the original image. Therefore, a person's face FM3c of the deformed image IM3c is deformed so as to be narrower than the face FG3 of the original image IG3. In addition, the width of the reduction area SGc in the original image IG3 is smaller than that when the reduction area SGc is arranged at the center of the image IG3. Therefore, even when the face FG3 is disposed at the end of the image IG3, it is possible to sufficiently increase the sum of the widths of the left and right enlarged areas EGLc and EGRc. Even though no blank is formed at the end of the deformed image IM3c in the deformation direction, it is possible to reduce the enlargement ratios of the enlarged areas EGLc and EGRc. As a result, it is possible to reduce the probability of incongruity occurring in a corrected image due to an increase in enlargement ratio.

As described above, in the fourth embodiment, since a reduction area having a face at its center is set, the face included in the reduction area is deformed so as to be narrowed. Therefore, even when a person is disposed at the end of an image, it is possible to deform the face so as to be narrowed. In addition, it is possible to sufficiently increase the width of an enlargement area by disposing the face at the center of the reduction area. As a result, it is possible to reduce the probability of incongruity occurring in a corrected image.

In the fourth embodiment, as shown in FIGS. 15A and 15B, the enlargement areas EGLc and EGRc are provided at both sides of the reduction area SGc in the deformation direction. However, the enlargement area may be provided at only one side of the reduction area according to the position of the face. When the distance between the position of the face and one end of the image is less than a predetermined value (for example, one twentieth of the length of the image in the deformation direction), no enlargement area may be provided at the one end of the image.

### E. Fifth Embodiment

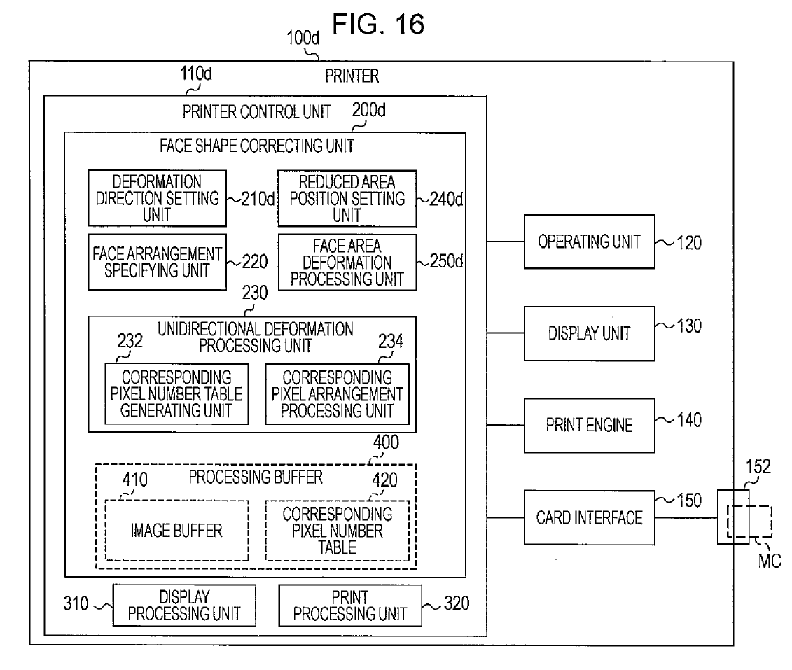

FIG. 16 is a diagram schematically illustrating the structure of a printer 100d according to a fifth embodiment of the invention. The printer 100d according to the fifth embodiment is similar to the printer 100c according to the fourth embodiment shown in FIG. 13 except that the functions of a deformation direction setting unit 210d and a reduced area position setting unit 240d are different from those in the fourth embodiment and a face area deformation processing unit 250d is provided in a face shape correcting unit 200d.

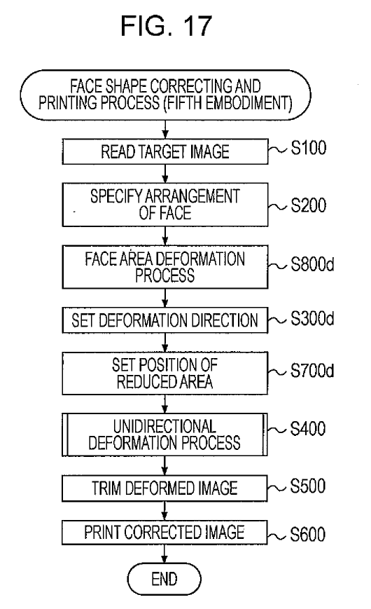

FIG. 17 is a flowchart illustrating the flow of a face shape correcting and printing process according to the fifth embodiment. The flowchart shown in FIG. 17 differs from the flowchart illustrating the flow of the face shape correcting and printing process according to the fourth embodiment shown in FIG. 14 in that Step S300d and S700d are substituted for Steps S300 and S700c respectively, and Step S800d is added between Step S200 and Step S300d.

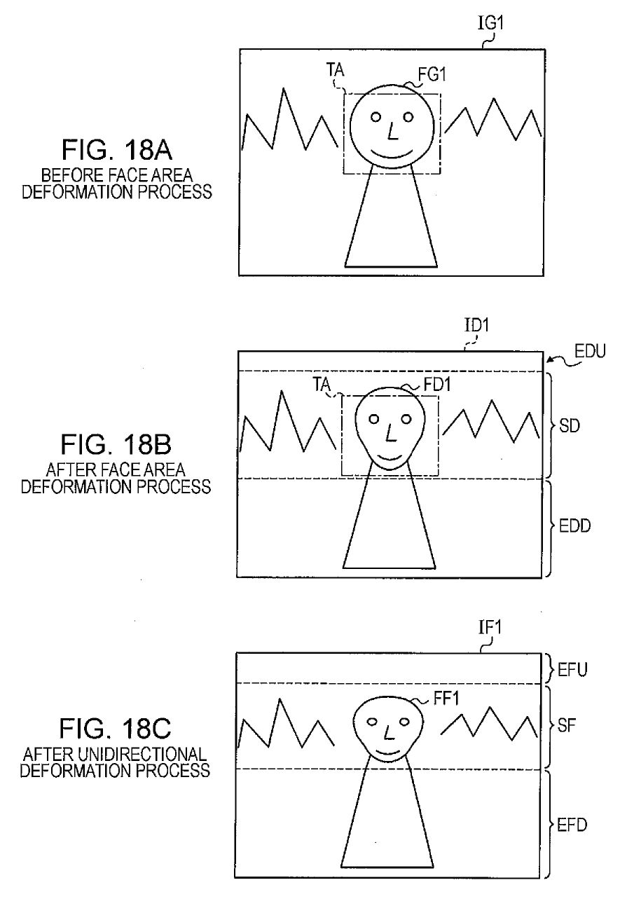

FIGS. 18A to 18C are diagrams illustrating an example in which a face shape correcting process is performed on an image IG1 corresponding to the thumbnail image TN1 shown in FIG. 2. FIG. 18A shows the original image IG1 before the face shape correcting process is performed. FIG. 18B shows an image ID1 subjected to a face area deforming process (which will be described below) in Step S800d. FIG. 18C shows a deformed image IF1 obtained by performing a unidirectional deformation process on the image ID1 in Step S400.

In Step S800d of FIG. 17, the face area deformation processing unit 250d sets a face area to be deformed, from the arrangement of the face specified in Step S200. Then, points in the face area after deformation are associated with (mapped to) points in the face area before deformation to deform an image in the set face area. A face area deforming process using mapping will be described below.

In the example shown in FIGS. 18A to 18C, a face area TA is set so as to be laid across a face FG1 shown in FIG. 18A. Then, a deforming process using mapping is performed to deform the shape of the face FG1 in the original image IG1. In the deformed image ID1, as shown in FIG. 18B, the cheek of a person's face FD1 is narrower than that of the face FG1 of the original image IG1 by the deforming process.

In Step S300d of FIG. 17, on the contrary to Step S300 in the fourth embodiment, when the inclination of the face is less than 45°, the deformation direction setting unit 210d sets the deformation direction to the vertical direction. On the other hand, when the inclination of the face is more than 45°, the deformation direction setting unit 210d sets the deformation direction to the horizontal direction. Then, in Step S700d, the reduced area position setting unit 240d sets the position of a reduction area on the basis of the arrangement of the face area in the deformation direction.

As shown in FIG. 18B, the deformation direction is set to the vertical direction of the image. The length of a reduction area SD in the vertical direction (deformation direction) is set to be greater than that of the face area TA. In addition, the face area TA is set below a person's forehead, which will be described below. Therefore, the upper end of the reduction area SD is set above the upper end of the face area TA. Enlargement areas EDU and EDD are arranged above and below the reduction area SD, respectively.

After the position of the reduction area is set in Step S700d (FIG. 17), the unidirectional deformation process is performed on the reduction area and the enlargement areas arranged outside the reduced area to generate a deformed image in Step S400.

As shown in FIG. 18C, in the deformed image IF1 subjected to the unidirectional deformation process, the length of a reduced area SF in the vertical direction is less than that of the reduced area SD of the image ID1, and the lengths of the enlarged areas EFU and EFD in the vertical direction are more than those of the enlarged areas EDU and EDD of the image ID1, respectively. As such, the face FD1 is deformed to be elongated in the vertical direction by the face area deforming process (Step S800d) and then deformed by the unidirectional deformation process (Step S400) such that the length thereof in the vertical direction is reduced. Therefore, even when the face area deforming process is performed to greatly correct the shape of the face such that the face is deformed to be elongated in the vertical direction, it is possible to make the ratio of the lengths of the face in the vertical direction and the horizontal direction equal to that in the original image IG1. Therefore, it is possible to prevent the face from looking to be extended while improving the efficiency of the face area deforming process. As a result, it is possible to obtain an image without incongruity.

As described above, in the fifth embodiment, even when the face is deformed to be elongated in the vertical direction by the face shape deforming process, it is possible to approximate the aspect ratio of the face to that of the original image by the unidirectional deformation process. Therefore, it is possible to reduce the incongruity of an image subjected to the face area deforming process.

### F. Specification of Arrangement of Face

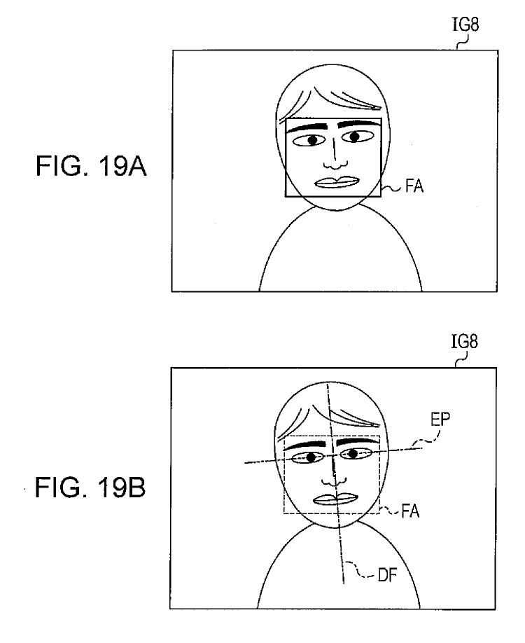

FIGS. 19A and 19B are diagrams illustrating an example of a process of specifying the arrangement of a face performed in Step S200 of FIG. 3. FIGS. 19A and 19B show an example in which the specifying process is performed on an image IG8 corresponding to the thumbnail image TN8 shown in FIG. 2.

In order to acquire the arrangement of a face, first, an area close to a face is detected from an image. FIG. 19A shows an example in which an area FA close to a face is detected from the image IG8. The area FA (hereinafter, referred to as a ‘detected face area FA’) is detected by a known face detecting method, such as pattern matching using a template (see JP-A-2004-318204). The detected face area FA is a rectangular area including the images of eyes, a nose, and a mouth of a person's face.

Then, the detected face area FA is analyzed and the positions of the left and right pupils in the detected face area FA are specified. A center line DF that is vertical to the line EP linking the specified positions of the left and right pupils and passes through the center of the left and right pupils is specified as a line that defines the position and the vertical direction of the face.

### G. Deformation of Face Area

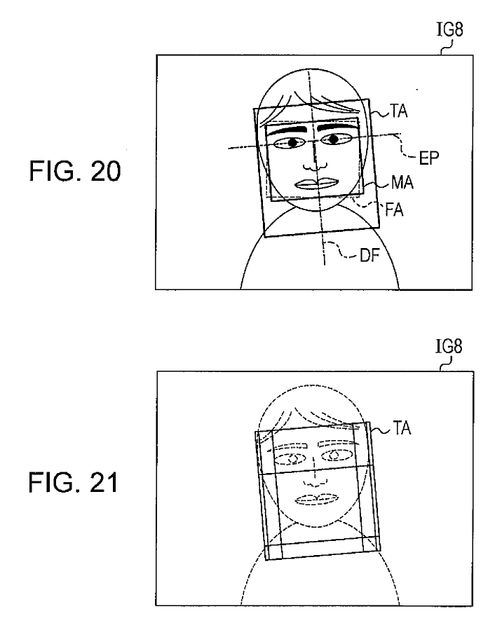

FIGS. 20 to 23 are diagrams illustrating an example of the face area deforming process performed in Step S800d of FIG. 17. FIGS. 20 to 23 show an example in which the face area deforming process is performed on the image IG8 corresponding to the thumbnail image TN8 shown in FIG. 2, similar to FIGS. 19A and 19B.

In the deformation of a face area, first, a mapping transformation area TA to be subjected to a deforming process using mapping is set on the basis of the arrangement of the face specified in Step S200. As shown in FIG. 20, the mapping transformation area TA is set as an area that extends from a portion below a jaw to a portion above an eyebrow in the vertical direction. In addition, the mapping transformation area is set so as to include the entire contour of the face in the vertical direction.

In the setting of the mapping transformation area TA, first, a face area MA obtained by adjusting the direction of the detected face area FA is set to be aligned with the inclination of the face. The face area MA whose inclination is adjusted extends to the upper direction of a line EP linking the pupils, the lower direction of the line EP linking the pupils, and the left and right directions of the center line DF at magnifications that are predetermined for the directions, thereby setting the mapping transformation area TA.

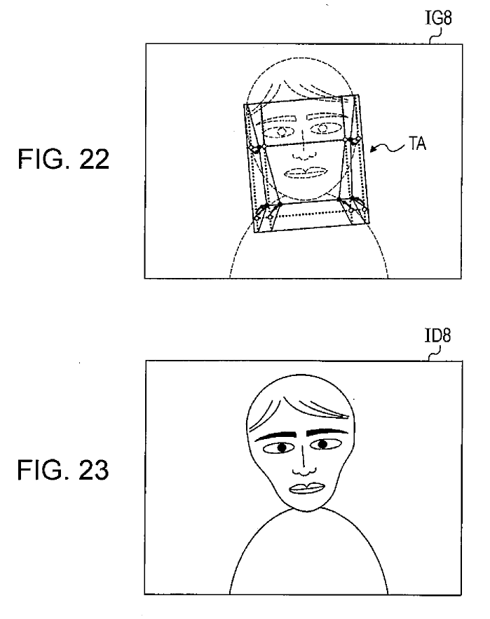

As shown in FIG. 21, the set mapping transformation area TA is divided into a plurality of small areas. Then, as shown in FIG. 22, mapping is performed such that lattice points before deformation that are represented by white circles are moved to lattice points after deformation that are represented by black circles. Then, the values of pixels are set on the basis of mapping to deform the image in the mapping transformation area TA, and an image ID8 in which a cheek is deformed to be narrowed is generated by the face area deforming process, as shown in FIG. 23.

As the face area deforming process, any deforming process may be used as long as it can deform an image in a deformed area. For example, a deforming method of reducing an image disposed at the center of a deformed area along the line EP and enlarging an image disposed at the end of the deformed area along the line EP may be used.

### H. Modifications

The invention is not limited to the above-described embodiments, but various modifications and changes of the invention can be made without departing from the scope and spirit of the invention. For example, the following modifications can be made.

### H1. First Modification

In the third to fifth embodiments, the enlargement area is enlarged at a constant enlargement ratio in the deformation direction. However, similar to the second embodiment, the enlargement ratio may vary depending on the distance from the reduction area.

### H2. Second Modification

In the above-described embodiments, the invention is applied to the face shape deforming process, but the invention may be applied to a deforming process that is different from the face shape deforming process. The invention can be applied to a general deforming process of deforming an object included in an image.

### H3. Third Modification

In the above-described embodiments, the invention is applied to a printer, but the invention may be applied to any apparatuses capable of performing the unidirectional deformation process on the original image. For example, the invention can also be applied to a personal computer or a digital camera having a function of performing an image deforming process.

### H4. Fourth Modification

In the above-described embodiments, some of the components implemented by hardware may be substituted for software. On the contrary, some of the components implemented by software may be substituted for hardware.

The present application claims the priority based on a Japanese Patent Application No. 2008-076255 filed on Mar. 24, 2008, the disclosure of which is hereby incorporated by reference in its entirety.

What is claimed is:

1. An image processing apparatus comprising:
a deformation area setting unit that sets an enlargement area and a reduction area in an image;
a deformation processing unit that enlarges the enlargement area in a specific direction and reduces the reduction area in the specific direction; and
a face detecting unit that detects a face in the image,
wherein the deformation area setting unit sets the enlargement area so as to be laid from an enlargement start position determined on the basis of the position of the face in the specific direction to the end of the image in the specific direction.

2. The image processing apparatus according to claim 1,
wherein, when the face detecting unit detects a plurality of faces, the deformation area setting unit sets the enlargement area on the basis of a face that is closest to the end of the image in the specific direction.

3. The image processing apparatus according to claim 1,
wherein the deformation area setting unit sets the enlargement area and the reduction area so as to be symmetric with respect to the center of the image in the specific direction.

4. The image processing apparatus according to claim 3,
wherein the reduction area is arranged at the center of the image in the specific direction, and
the deformation processing unit performs the reduction and the enlargement from the center to the end of the image in the specific direction.

5. The image processing apparatus according to claim 1,
wherein the deformation area setting unit sets the reduction area as an area including a portion of the face.

6. The image processing apparatus according to claim 5,
wherein, when a distance between one end of the image in the specific direction and the reduction area is less than a predetermined value, the deformation area setting unit sets the enlargement area only between the reduction area and the other end of the image.

7. The image processing apparatus according to claim 6,
wherein the deformation processing unit performs the reduction and the enlargement from the one end of the reduction area and the other end thereof.

8. The image processing apparatus according to claim 5,
wherein, when the enlargement areas are sets at both sides of the reduction area in the specific direction, the deformation processing unit performs the reduction and the enlargement from the center of the reduction area to the end of the image.

9. An image processing method comprising:
setting an enlargement area and a reduction area in an image;
enlarging the enlargement area in a specific direction and reducing the reduction area in the specific direction; and
detecting a face in the image,
wherein the enlargement area is set so as to be laid from an enlargement start position determined on the basis of the position of the face in the specific direction to the end of the image in the specific direction.

10. A computer program for image processing that allows a computer to perform the functions of:
setting an enlargement area and a reduction area in an image;
enlarging the enlargement area in a specific direction and reducing the reduction area in the specific direction; and
detecting a face in the image,
wherein the enlarged area is set so as to be laid from an enlargement start position determined on the basis of the position of the face in the specific direction to the end of the image in the specific direction.
